(19) United States
(12) Patent Application Publication
(10) Pub. No.: US 2007/0018942 A1
(43) Pub. Date: Jan. 25, 2007

(54) LIGHT SOURCE DRIVING DEVICE

(76) Inventor: Atsunori Ooyama, Fukaya-shi (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(21) Appl. No.: 11/458,872

(22) Filed: Jul. 20, 2006

(30) Foreign Application Priority Data
Jul. 25, 2005 (JP) 2005-214460

(51) Int. Cl. G09G 3/36

(52) U.S. Cl. 345/102

(57) ABSTRACT

A light source driving device includes a switching circuit which switches a direct-current voltage supplied externally, a piezoelectric transformer which raises the voltage output from the switching circuit and which allows an alternating current to flow through a cold-cathode fluorescent tube, and a control circuit to change the duty ratio as a ratio per unit time at which the alternating current is output from the switching circuit in order to dim the cold-cathode fluorescent tube. The switching circuit includes resistors RA, RB which set the tilt of the envelope waveform to increase the fall time of the envelope waveform of the alternating current flowing through the cold-cathode fluorescent tube.

### CROSS-REFERENCE TO RELATED APPLICATIONS

This application is based upon and claims the benefit of priority from prior Japanese Patent Application No. 2005-214460, filed Jul. 25, 2005, the entire contents of which are incorporated herein by reference.

### BACKGROUND OF THE INVENTION

1. Field of the Invention

The present invention generally relates to a light source driving device for a liquid crystal display panel, particularly to a light source driving device which drives a discharge lamp light source such as a cold-cathode fluorescent tube.

2. Description of the Related Art

Liquid crystal display panels are broadly utilized as displays for personal computers, portable information terminals, television receivers, car navigation systems and the like. In a case where the liquid crystal display panel is of a transmissive type, in general, a discharge lamp light source such as a cold-cathode fluorescent tube is disposed as a backlight in the liquid crystal display panel, and driven by a light source driving device using, for example, a piezoelectric transformer.

A conventional light source driving device employs a burst dimmer system in which the duty ratio of an alternating voltage output to the piezoelectric transformer is varied with a pulse width modulation (PWM) signal to control luminance of the cold-cathode fluorescent tube (see, e.g., Jpn. Pat. Appln. KOKAI Publication No. 10-66353).

FIG. 4 shows the waveform of an alternating current which intermittently flows from the piezoelectric transformer to the cold-cathode fluorescent tube in order to obtain a desired luminance in the conventional light source driving device. Since the cold-cathode fluorescent tube repeatedly turns on and off in accordance with this alternating current, the luminance can be adjusted over a broad range, but a very large noise is generated. The main cause of this noise is vibration of the piezoelectric transformer. As a measure to reduce the vibration of the piezoelectric transformer, heretofore structure changing of the piezoelectric transformer, molding for vibration absorption or the like has generally been performed. In Jpn. Pat. Appln. KOKAI Publication No. 10-66353, there is disposed, as this measure, an envelope generation circuit or the like which sets a voltage waveform to be applied to the piezoelectric transformer. However, any measure results in a substantial increase in manufacturing time or manufacturing cost.

### BRIEF SUMMARY OF THE INVENTION

The present invention has been developed in view of such problem, and an object is to provide a light source driving device which can suppress noise generated during driving without requiring any substantial increase in manufacturing time or manufacturing cost.

According to the present invention, there is provided a light source driving device including: a switching circuit which switches a direct-current voltage supplied externally; a piezoelectric transformer which boosts a voltage output from the switching circuit to provide an alternating current flowing through a discharge lamp light source; and a control circuit which varies the duty ratio of the output voltage from the switching circuit as a control for dimming the discharge lamp light source; wherein the switching circuit includes a waveform setting section which sets an envelope waveform inclination for increasing the fall time of the envelope waveform of the alternating current flowing though the discharge lamp light source.

In this light source driving device, the waveform setting section of the switching circuit sets an envelope waveform inclination for increasing the fall time of the envelope waveform of the alternating current flowing though the discharge lamp light source. Accordingly, falling of the envelope waveform of the alternating current flowing through the discharge lamp light source is made dull by the inclination. This suppresses noise that is generated by vibration of the piezoelectric transformer. Further, the waveform setting section may be formed of resistors or the like, instead of a complicated circuit which is used to control the waveform of a voltage applied to the discharge lamp light source. Thus, any substantial increase in manufacturing time or manufacturing cost is not required.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a diagram schematically showing the configuration of a transmissive type liquid crystal display device according to one embodiment of the present invention;

FIG. 2 is a diagram showing the configuration of a backlight driver shown in FIG. 1;

FIG. 3 is a diagram showing the envelope waveform of an alternating current flowing from a piezoelectric transformer to a cold-cathode fluorescent tube shown in FIG. 2; and

FIG. 4 is a diagram showing the envelope waveform of an alternating current flowing through a discharge lamp light source driven by a conventional light source driving device.

### DETAILED DESCRIPTION OF THE INVENTION

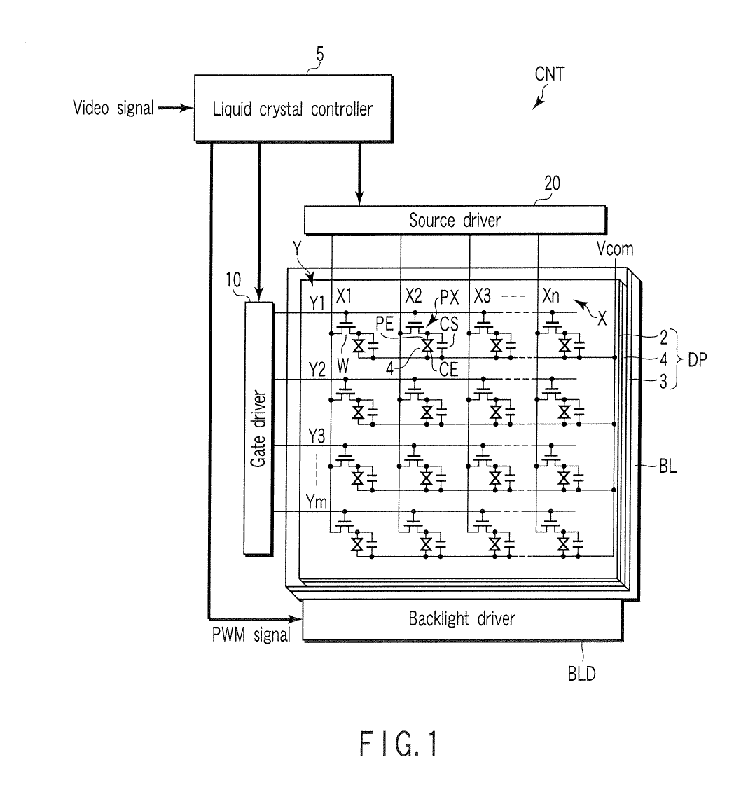

There will be described hereinafter a liquid crystal display device according to one embodiment of the present invention with reference to the accompanying drawings. FIG. 1 schematically shows the configuration of this liquid crystal display device. The liquid crystal display device includes a transmissive type liquid crystal display panel DP having a plurality of liquid crystal pixels PX; a backlight BL which illuminates the liquid crystal display panel DP, and a control unit CNT which controls the liquid crystal display panel DP and the backlight BL. The liquid crystal display panel DP has a structure in which a liquid crystal layer 4 is held between an array substrate 2 and a counter substrate 3.

The array substrate 2 has a plurality of pixel electrodes PE arrayed in a matrix on a transparent insulating substrate such as glass, a plurality of gate lines Y (Y1 to Ym) arranged along the rows of pixel electrodes PE, a plurality of source lines X (X1 to Xn) arranged along the columns of pixel electrodes PE, and pixel switching elements W arranged near intersections between the gate lines Y and the source lines X. Each pixel switching element W is formed of, for example, a polysilicon thin-film transistor. In this case, the thin-film transistor has a gate connected to one gate line Y, and a source-to-drain path connected between one source line X and one pixel electrode PE.

The counter substrate 3 includes a color filter (not shown) disposed on a transparent insulating substrate such as glass, and a common electrode CE disposed on the color filter to face the pixel electrodes PE, for example. The pixel electrodes PE and the common electrode CE are made of a transparent electrode material such as ITO. Each of the pixel electrode PE and the common electrode CE serve as a liquid crystal pixel PX together with a pixel region of the liquid crystal layer 4 which is located between the pixel electrode PE and the common electrode CE and in which the alignment of liquid crystal molecules is controlled by an electric field between the electrodes PE and CE. All the pixels PX have storage capacitances Cs. These storage capacitances Cs are obtained by electrically connecting the common electrode CE to a plurality of storage capacitance lines capacitively coupled to the rows of pixel electrodes PE on an array substrate 2 side. A common voltage Vcom is supplied to the common electrode CE.

The control unit CNT includes a liquid crystal controller 5, a gate driver 10, a source driver 20 and a backlight driver BLD. The liquid crystal controller 5 controls the gate driver 10, the source driver 20 and the backlight driver BLD in order to display, as an image in the display panel DP, a digital video signal VIDEO supplied externally. The gate driver 10 is connected to the gate lines Y, and sequentially drives the gate lines Y. The source driver 20 is connected to the source lines X, and drives the source lines X while each of the respective gate lines Y is driven. The backlight driver BLD turns on the backlight BL during the driving of the liquid crystal display panel DP. Furthermore, this backlight driver BLD is configured to vary the average on-period with a PWM signal supplied from the liquid crystal controller 5 or the outside to thereby control luminance of the backlight BL. Here, the frequency of the PWM signal is set to 160 Hz. The backlight BL is a surface light source formed by combining a discharge lamp light source such as the cold-cathode fluorescent tube with a light guide plate which guides light from this discharge lamp light source to the whole display area of the liquid crystal display panel DP.

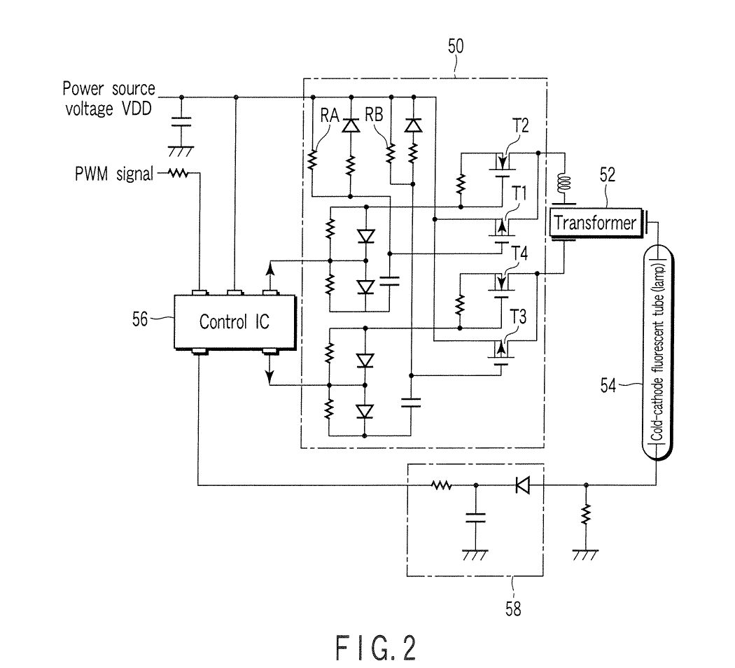

FIG. 2 shows the configuration of the backlight driver BLD. This backlight driver BLD is a light source driving device of an inverter type, and includes a switching circuit 50 which switches a direct-current power source voltage VDD supplied externally, a piezoelectric transformer 52 which boosts a voltage output from the switching circuit 50 to provide an alternating current flowing through a cold-cathode fluorescent tube 54 (the discharge lamp light source of the backlight BL), and a controller IC 56 which sets the switching frequency of the switching circuit 50 and varies the duty ratio of the output voltage from the switching circuit 50 as a control for dimming the cold-cathode fluorescent tube 54. The switching circuit 50 has a MOS transistor Ti connected between a primary-side first electrode of the piezoelectric transformer 52 and an input end of the power source voltage VDD, a MOS transistor T2 connected between the primary-side first electrode of the piezoelectric transformer 52 and a non-inverted control output end of the controller IC 56, a MOS transistor T3 connected between a primary-side second electrode of the piezoelectric transformer 52 and the input end of the power source voltage VDD, and a MOS transistor T4 connected between the primary-side second electrode of the piezoelectric transformer 52 and an inverted control output end of the controller IC 56. The controller IC 56 generates switching control voltages which are alternately set to the VDD level and the ground level and output from the non-inverted and inverted output ends in a complementary relation. Here, the switching control voltages are set to a frequency of 55 kHz, and controlled to have a duty ratio corresponding the PWM signal. Accordingly, the MOS transistors T1, T4 and the MOS transistors T3, T2 alternately are made conductive to apply a voltage between the primary-side first and second electrodes of the piezoelectric transformer 52. This voltage is boosted by the piezoelectric transformer 52 to provide an alternating current that flows from the secondary-side electrode to the cold-cathode fluorescent tube 54. The frequency of the alternating current is 55 kHz which is equal to the frequency of the switching control voltages. The cold-cathode fluorescent tube 54 turns on in a state in which this alternating current flows. The ratio of an on-period per unit time is substantially equal to the duty ratio of the PWM signal. The alternating current flowing through the cold-cathode fluorescent tube 54 is detected by a current detecting section 58, and fed back to the controller IC 56. The controller IC 56 adjusts the switching control voltages based on the detection result.

The switching circuit 50 has a resistor RA connected between the input end of the power source voltage VDD and a gate of the MOS transistor Ti and a resistor RB connected between the input end of the power source voltage VDD and a gate of the MOS transistor T3. These resistors RA and RB are 15 kΩ, and are provided as a waveform setting section which sets an envelope waveform inclination for increasing the fall time of the envelope waveform of the alternating current flowing through the cold-cathode fluorescent tube 54.

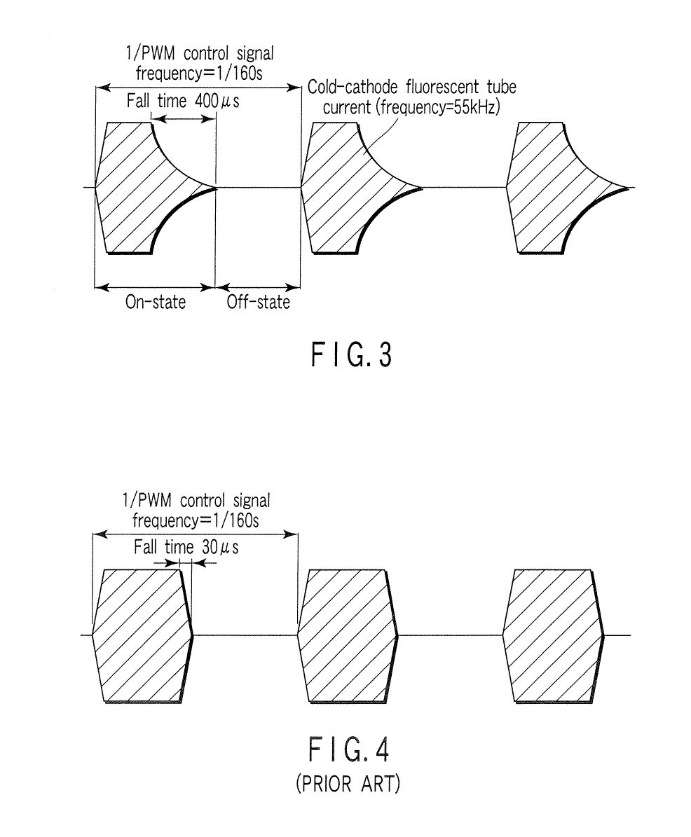

Assuming that each of the resistors RA and RB is 15 kΩ, the frequency of the alternating current flowing through the cold-cathode fluorescent tube 54 is 55 kHz, and the frequency of the PWM signal is 160 Hz, as shown in FIG. 3, the fall time (transfer time required to transfer the cold-cathode fluorescent tube 54 from an on-state to an off-state) of the envelope waveform of the alternating current flowing through the cold-cathode fluorescent tube 54 is set to 400 μs. In this case, the noise level is measured as 27 dB. When each of the resistors RA and RB is changed to 10 kΩ, the fall time of the envelope waveform of the alternating current is set to 200 μs. In this case, the noise level is 29 dB.

In a conventional example shown in FIG. 4, the fall time of the envelope waveform of the alternating current flowing through the cold-cathode fluorescent tube 54 is less than 100 μs, and the noise level is 32 dB. The fall time below 100 μs is obtained by setting each of the resistors RA and RB to, for example, 5 kΩ on the same conditions that the frequency of the alternating current flowing through the cold-cathode fluorescent tube 54 is 55 kHz and the frequency of the PWM signal is 160 Hz.

In the present embodiment, when each of the resistors RA and RB is set to 15 kΩ, noise can be reduced as much as 5 dB as compared with the conventional example. When each of the resistors RA and RB is set to 10 kΩ, the noise can be reduced as much as 3 dB as compared with the conventional example. That is, when resistances of the resistors RA and RB are changed to set the inclination in which the fall time of the envelope waveform of the alternating current flowing through the cold-cathode fluorescent tube 54 increases to 100 μs or more, the falling envelope waveform of the alternating current flowing through the cold-cathode fluorescent tube 54 is made dull by the inclination, and the noise generated by vibration of the piezoelectric transformer 52 can be suppressed. The change of the resistances of the resistors RA and RB does not require any substantial increase in manufacturing time or manufacturing cost.

It is to be noted that the present invention is not limited to the above embodiment, and can variously be modified without departing from the scope of the present invention.

In the above embodiment, the resistors RA and RB are formed of fixed resistors, but may have resistances which are varied with the PWM signal in order to increase the fall time of the envelope waveform of the alternating current flowing through the cold-cathode fluorescent tube 54.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general invention concept as defined by the appended claims and their equivalents.

What is claimed is:

1. A light source driving device comprising:
a switching circuit which switches a direct-current voltage supplied externally;
a piezoelectric transformer which boosts a voltage output from the switching circuit to provide an alternating current flowing through a discharge lamp light source; and
a control circuit which varies the duty ratio of the output voltage from the switching circuit as a control for dimming the discharge lamp light source;
wherein the switching circuit includes a waveform setting section which sets an envelope waveform inclination for increasing the fall time of the envelope waveform of the alternating current flowing though the discharge lamp light source.

2. The light source driving device according to claim 1, wherein the control circuit is configured such that the duty ratio of the output voltage from the switching circuit is varied with a pulse width modulation signal supplied externally.

3. The light source driving device according to claim 1, wherein the waveform setting section is a resistor section which varies the fall time with a pulse width modulation signal supplied externally.

4. The light source driving device according to claim 1, wherein the discharge lamp light source is a cold-cathode fluorescent tube.
